(19) United States
(12) Patent Application Publication
(10) Pub. No.: US 2005/0184970 A1
(43) Pub. Date: Aug. 25, 2005

(54) Touch control attachment

(75) Inventors: Theodore A. Wegert, Louisville, KY (US); Karen J. Cary, Louisville, KY (US); Jens Hoche, Napierville, IL (US); Alexander Haas, Wiesbaden (DE); Thomas Zenker, Nieder-Olm (DE); Steffen Astheimer, Idstein (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Corporation, Elmsford, NY (US)

(21) Appl. No.: 11/012,451

(22) Filed: Dec. 15, 2004

Related U.S. Application Data
(60) Provisional application No. 60/529,553, filed on Dec. 15, 2003.

(51) Int. Cl. G09G 5/00

(52) U.S. Cl. 345/173

(57) ABSTRACT

The present invention provides a touch control assembly including a substrate for interfacing with a user and a touch keypad removably connected to the substrate. The touch keypad includes a sensor.

### CROSS REFERENCE TO RELATED APPLICATION(S)

This application claims the benefit of U.S. provisional application No. 60/529,553, filed Dec. 15, 2003, which is incorporated by reference as if fully set forth.

### BACKGROUND

A growing percentage of household and industrial machines incorporate electronic touch controls for manual actuation. These touch controls usually use capacitive sensors or other non-mechanical devices located behind a protective substrate to sense the touch of a user on the substrate without requiring direct physical contact with the electronic controls. Since no mechanical switches are needed, required maintenance is decreased, and the touch controls can be completely sealed from the environment while remaining completely functional.

Touch controls typically include a flat etched circuit board, known as a touch keypad, which contains capacitive or other non-contact sensors printed thereon. A controller is provided either remotely or integral with the keypad. A flat surface of the keypad is attached to one side of a flat substrate, or to a material having a constant dielectric constant located behind the substrate, while the opposite side of the substrate provides an interface with the user. The substrate is usually a non-porous plastic, glass, or glass-ceramic screen able to protect the electronics behind it. The user-interface side of the substrate is typically printed with indicia corresponding to sensor locations of the underlying keypad. When a user touches the substrate in a given location, the corresponding sensor on the keypad sends a signal to the controller.

The touch keypad is traditionally attached to the substrate mechanically, using screws or fasteners, using double-sided very high bond (VHB) adhesive tape, or with dispensed adhesives such as silicone epoxy or acrylic. On delicate substrates such as glass and glass-ceramic, mechanical attachment is not possible, and adhesive methods are employed. However, adhesive methods result in permanent attachment of the keypad with the substrate, making removal for rework during assembly, maintenance or repair impossible. This presents a problem as both the substrates and keypads are often costly.

Adhesive tapes which can be removed from a surface by stretching are known in the art. One such tape includes a removable adhesive tape strip including a highly extensible and substantially inelastic backing and a layer of pressure sensitive adhesive. When applied to a support surface, the adhesive tape becomes firmly bonded thereto, but can be easily removed without damaging the support surface by simply stretching the tape, using a provided tab, in a direction parallel to the support surface. It is also known to use a double-sided stretch release adhesive tape strip to attach two articles together, with a means being provided for gripping the stretch release adhesive tape strip.

It would be desirable to provide a method of securely attaching an electronic keypad to a flat substrate which allows for selective removal of the keypad. Such a method should not sacrifice the strength of attachment for ease of removability of the joined components.

### SUMMARY

The present invention provides a touch control assembly including a glass or a glass-ceramic substrate for interfacing with a user, and a touch keypad removably connected to the substrate.

In another embodiment of the present invention a touch control assembly having a touch keypad, a substrate for interfacing with a user, and at least one double-sided stretch release tape strip connecting the touch keypad with the substrate is provided.

The present invention also provides a touch control assembly having a touch keypad, a substrate, a controller which receives signals from the touch keypad, and a spring which urges the keypad against the substrate to removably secure the keypad with the substrate.

In another embodiment, the present invention provides a touch control assembly having a touch keypad, a substrate and a bracket connected to the substrate which removably connects the keypad to the substrate.

In another embodiment, the present invention provides a touch control assembly having a touch keypad, a substrate, and at least one clip which removably connects the keypad to the substrate.

In another embodiment, the present invention provides a touch control assembly having a touch keypad, a substrate, and an interlocking appendage fastening system including a first layer connected to the substrate, and a second layer connected to the keypad which removably connects to the first layer to connect the keypad to the substrate.

In another embodiment, the present invention provides a touch control assembly having a touch keypad, a substrate, and a magnet which removably connects the keypad to the substrate.

In another embodiment, the present invention provides a method for providing a touch control assembly.

### BRIEF DESCRIPTION OF THE DRAWINGS

FIG. 1 is a perspective view of a touch control assembly according to the preferred embodiment of the present invention

FIG. 2 is a partially exploded view of the touch control assembly of FIG. 1.

FIG. 3 is a partially exploded view of an alternative preferred embodiment of a touch control assembly.

FIG. 4 is a perspective view of a touch control assembly according to another preferrred alternative embodiment of the present invention.

FIG. 5 is an exploded view of another alternative preferred embodiment of a touch control assembly.

FIG. 6 is an exploded view of another alternative preferred embodiment of a touch control assembly.

FIG. 7 is an exploded view of another alternative preferred embodiment of a touch control assembly.

FIG. 8 is an exploded view of another alternative preferred embodiment of a touch control assembly.

FIG. 9 is an elevation view of another alternative preferred embodiment of a touch control assembly.

FIG. 10 is an elevation view of another alternative preferred embodiment of a touch control assembly.

FIG. 11 is an elevation view of another alternative preferred embodiment of a touch control assembly.

### DETAILED DESCRIPTION OF THE PREFERRED EMBODIMENTS

Certain terminology is used in the following description for convenience only and is not considered limiting. Words such as “front”, “back”, “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted.

The preferred embodiments of the present invention will be described with reference to the drawing figures where like numerals represent like elements throughout.

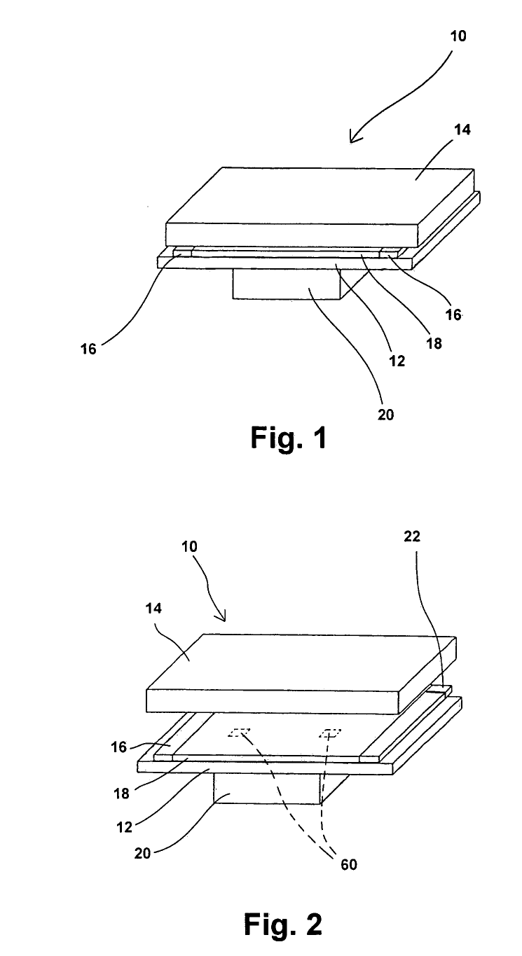

Referring to FIGS. 1 and 2, a touch control assembly 10 according to a preferred embodiment of the invention is shown. A touch keypad 12 is attached to a substrate 14 by double-sided stretch release tape strips 16, such as those available from 3M Company. The touch keypad 12 is preferably an etched circuit board of the type known in the art, and includes at least one touch sensor 60, preferably a capacitive-type sensor, which can sense the presence of a user's finger on the substrate 14. The substrate 14 is preferably formed from glass or glass-ceramic plate, or alternatively plastic sheet, and may be formed integral with a display panel on a household appliance or industrial apparatus. A controller 20 is shown integral with the keypad 12, but may alternatively be located in any desired location with respect to the other components.

The keypad 12 may be placed directly on the substrate 14. However, in accordance with a preferred embodiment of the invention an even coating of insulating material 18 having a uniform dielectric constant is used to fill an air gap between the keypad 12 and the substrate 14. The material 18 may be applied to either one of the keypad 12 or the substrate 14 and allowed to cure. The material is preferably silicone, which may be sprayed, screen-printed or stencil printed in a desired thickness, and which adheres well to glass and glass-ceramic surfaces. Other types of easily applied insulating materials, most preferably clear elastomers, can also be used to fill the air gap. Without this insulating material 18 in the air gap, any sensor 60 on the keypad 12, especially a capacitive sensor, may suffer from unreliability as a result of the potentially varying and unpredictable permittivity of the air gap.

The stretch release tape strips 16 are of the type known in the art, and each includes one releasing and one non-releasing adhesive layer on opposite faces of a backing layer, or may include both adhesive layers as releasing adhesive layers, to join the keypad 12 to the substrate 14. The releasing adhesive layer may face either the keypad or substrate 12, 14, depending on the design criteria, or may face both. The adhesive layers preferably include a silicone, rubber or acrylic-based pressure sensitive elastomeric adhesive, compatible with both the keypad 12 and the substrate 14. Each of the tape strips 16 includes a release tab 22, which, when pulled in a direction parallel to the joined surfaces, effects a stretch release of the releasing adhesive layer thereby freeing the joined components 12, 14.

Preferably, the insulating material 18 has the same thickness as the tape strips 16 and therefore completely fills the air gap to provide uniform permittivity between the keypad 12 and the substrate 14. Alternatively, one of the keypad 12 and the substrate 14 may be provided with recesses which receive the tape strips 16 such that the keypad 12 and the substrate 14 contact each other when assembled and no insulating material is required. Tape strips of the type described are typically provided in thin strips approximately 1/4″ to ¾″ wide and 3″ to 5″ long. No matter the configuration of the device, the tape strips 16 must be arranged such that their respective ends 22 are accessible to a user.

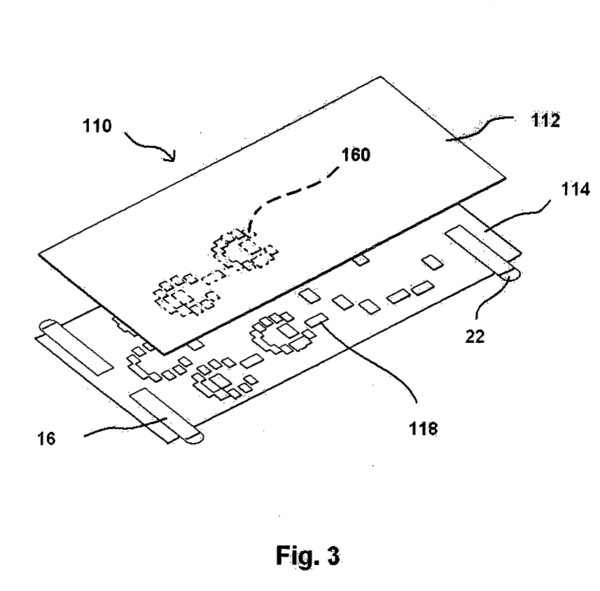

FIG. 3 shows a touch control assembly 110 having a large keypad 112 according to an alternative preferred embodiment of the present invention, which requires four tape strips 16 to secure the keypad 112 to a substrate 114. In this case, insulating material 118 of the same thickness as the tape is applied selectively to the substrate 114 in locations corresponding to touch sensors 160 and other components 160 which could benefit from an insulating layer.

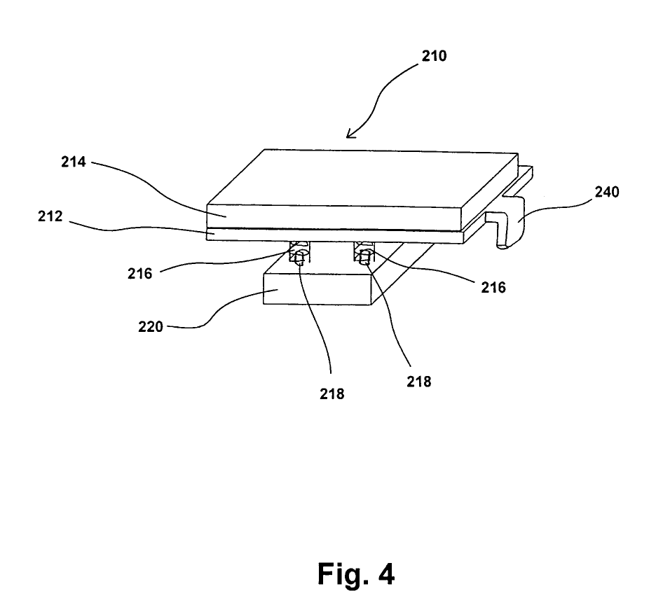

Referring to FIG. 4, an alternative preferred embodiment of the present invention is shown which eliminates the need for fasteners or adhesives in securing a keypad to a substrate. A touch control assembly 210 is provided that includes springs 216 arranged between a controller 220 and a keypad 212. The springs 216 pressure the keypad 212 directly against a substrate 214. Since no air gap exists in this configuration, the need for any insulating material between the keypad 212 and substrate 214 is eliminated. However, a layer of silicone or other suitable dielectric material may be applied between the keypad and substrate to assure an adequate contact surface. Alternatively, the springs may be arranged in other suitable locations with respect to the keypad 212, and the controller may be located integral with the keypad 212, as shown in FIGS. 1 and 2, or otherwise located remotely.

The springs 216 are preferably partially enclosed coil compression springs retained by anchoring studs 218; however, any suitable springs may be used including leaf springs. The keypad 212 may be easily removed from its position against the substrate 214 by sliding the keypad 212 away from the substrate. A handle tab 240 and/or a mechanism for releasing spring force (not shown) may be provided to facilitate removal of the keypad 212. Also, cooperating portions (not shown) of the keypad 212 and substrate 214 may be provided to allow precise alignment of the mating components 212, 214. Alternatively, the springs 216 may function to drive pins or detents (not shown) into cooperating portions (not shown) of the touch keypad 212 to securely align and retain the keypad 212 against the substrate 214.

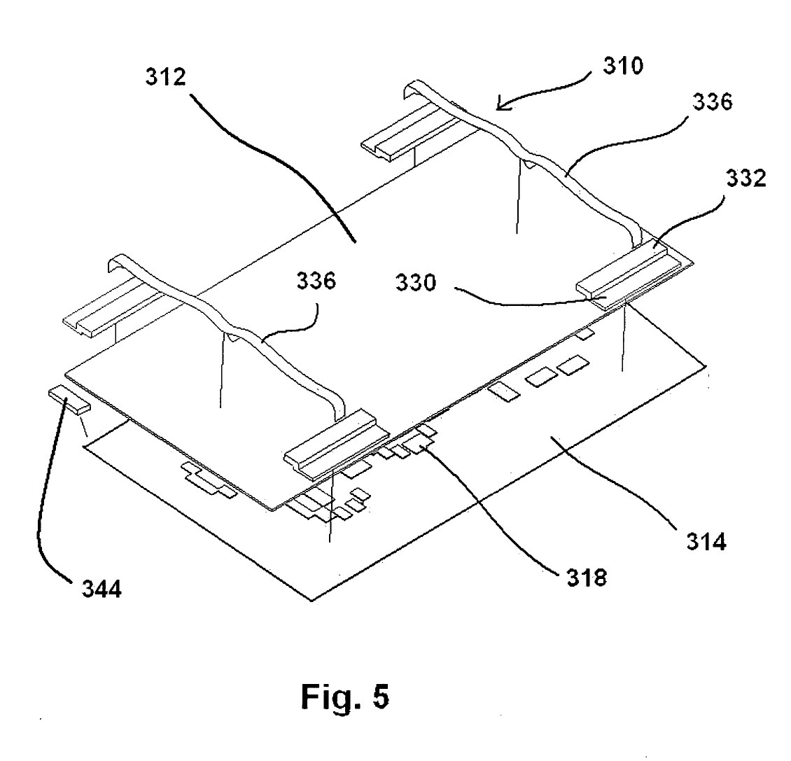

Referring now to FIG. 5, another preferred embodiment 310 of the present invention is shown. In this embodiment, brackets 330 are connected to a substrate 314 to removably retain a keypad 312. The brackets 330 are preferably permanently adhered to the substrate 314 using an adhesive, such as a silicone, rubber or acrylic-based pressure sensitive elastomeric adhesive. Preferably, to maintain a uniform dielectric constant, a coating of insulating material 318, preferably a clear elastomeric material such as silicone, is applied and allowed to cure on one of the substrate 314 and the keypad 312. The insulating material 318 may be applied to the entire surface of the substrate 314 or keypad 312. Alternatively, as shown, the insulating material 318 may be applied on the substrate 314 or the keypad 312, preferably via screen printing, in select locations corresponding to locations where touch sensors or other components, such as LEDs, are positioned on the keypad 312.

During assembly, keypad 312 is slid between the substrate 314 and a raised portion 332 of the bracket 330. Preferably, one or more alignment members, such as a stop member 344, is provided to assure proper alignment of the keypad 312 with the substrate 314. The stop member 344 may be adhered to or formed integrally with the substrate 314, or formed integrally with one or more of the brackets 330. Preferably, one or more spring clips 336 are provided to apply force to a back surface of the keypad 312 so that the keypad 312 maintains continuous contact with the substrate along its entire front surface. The spring clips 336 are preferably removably mechanically connected to the bracket 330, and may be removed during installation or replacement of the keypad 312. Alternatively, the spring clips 336 may be permanently or removably installed to the substrate 314 or to another suitable structure. The brackets 330 and springs 336 may be fabricated out of metal, plastic or any suitable material.

If the keypad 312 is fabricated using a sufficiently rigid and thick material, the spring clips 336 may be eliminated. The brackets 330 will hold a rigid and thick keypad 312 flush against the substrate 314 without the assistance of spring clips. Further, the brackets 330 may be fabricated from elastic material to allow the keypad 312 to fit tight against the substrate 314 without the use of additional springs.

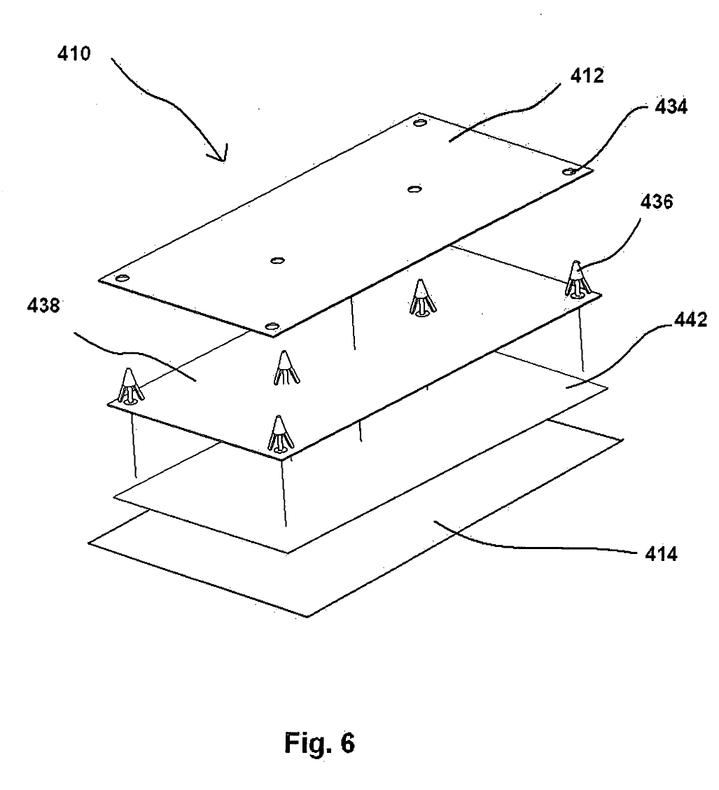

Referring now to FIG. 6, another preferred embodiment 410 of the present invention is shown. A keypad 412 is provided which includes a plurality of spaced apertures 434 for receiving clips 436. The clips 436 are preferably attached to a thin sheet material 438 which is adhered to a substrate 414 using an adhesive 442. The thin sheet material 438 is preferably plastic. The adhesive 442 is preferably a double-sided VHB tape or an elastomeric adhesive such as silicone. Also, the thin sheet material 438 and the adhesive 442 are preferably insulating materials having a uniform dielectric constant to assure proper functioning of any sensors of the keypad 412, especially capacitive sensors, which may suffer from unreliability as a result of varying or unpredictable permittivity. While a single piece of thin sheet material 438 and a single continuous layer of adhesive 442 is shown, multiple pieces of thin sheet material 438 and/or multiple adjacent layers of adhesive 442 may be provided. The clips 436 are preferably plastic tree clips having elastically deformable bodies able to removably retain the keypad 412. The clips 436 are capable of being reused when a keypad 412 requires replacement. In an alternative preferred embodiment, the clips 436 may be adhered directly to the substrate 414, in which case the thin sheet material 438 could be provided only as an insulator positioned between the keypad 412 and the substrate 414. In another embodiment, clips could be adhered to the keypad 412 to removably connect with apertures in the substrate 414.

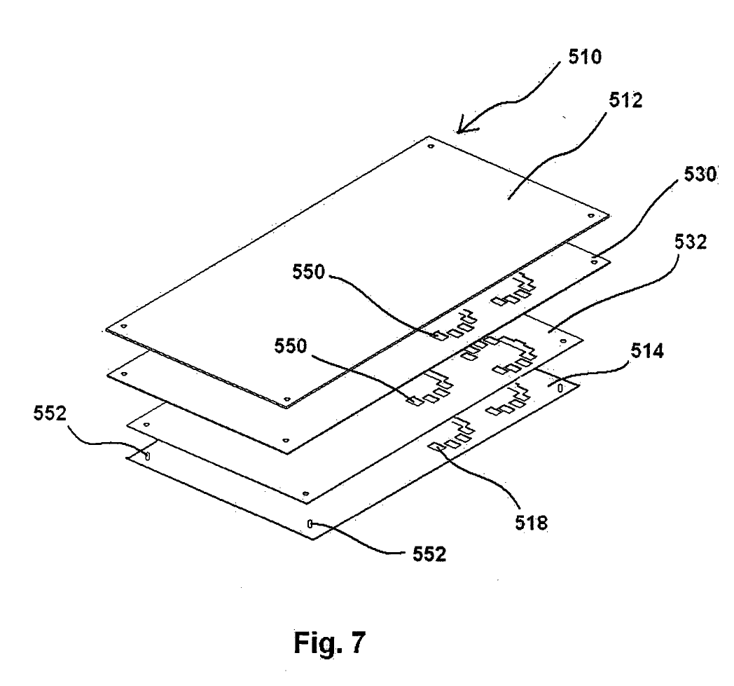

FIG. 7 shows another alternative preferred embodiment 510 in which a first layer 530 of an interlocking appendage fastening system is attached to a keypad 512, and a second layer 532 of the interlocking appendage fastening system is attached to a substrate 514. The first and second layers 530, 532 of the interlocking appendage fastening system include interlocking portions to allow the layers 530, 532 to removably attach to each other, thereby allowing removable attachment of the keypad 512 to the substrate 514. The interlocking appendage fastening system may be a traditional hook to loop fastening system, wherein one of the first and second layers includes a plurality of hooks, and the other layer includes a plurality of loops which removably connect to the plurality of hooks. Other interlocking appendage fastening systems may be used, such as hook to hook fastening systems or any fastening system using a plurality of appendages disposed on a sheet which removably connect to a plurality of appendages on an opposing sheet. The first and second layers 530,532 are preferably adhered to the keypad 512 and substrate 514 respectively using an adhesive such as an acrylic adhesive, silicone adhesive, rubber adhesive or other suitable adhesive. Alternatively, mechanical fasteners may be used to attach the layers 530,532 to the keypad 512 and/or the substrate 514.

Preferably apertures 550 are provided on the layers 530, 532 corresponding to sensors, LEDs or other devices on the keypad 512. Alternatively, the layers 530, 532 may include thin strips of material which are positioned to avoid interfering with devices on the keypad 512. Preferably, to maintain a uniform dielectric constant, insulating material 518 such as silicone, is applied to the substrate 514 in select locations corresponding to the positioning of apertures 550 or other openings in the layers 530, 532 between the keypad 512 and the substrate 514. The insulating material 518 is preferably applied at a thickness adequate to fill any gap between the keypad 512 and the substrate 514.

Alignment pins 552 are preferably adhered to the substrate 514. Pins 552 mate with apertures 554 in the layers 530, 532 as well as apertures 556 in the keypad 512 to properly align the keypad 512 with the layers 530, 532 and the substrate 514. Alternatively, pins 552 may be positioned on the keypad 512 and apertures located on the substrate 514, or other types of alignment members may be employed to align the keypad 512 with the substrate 514.

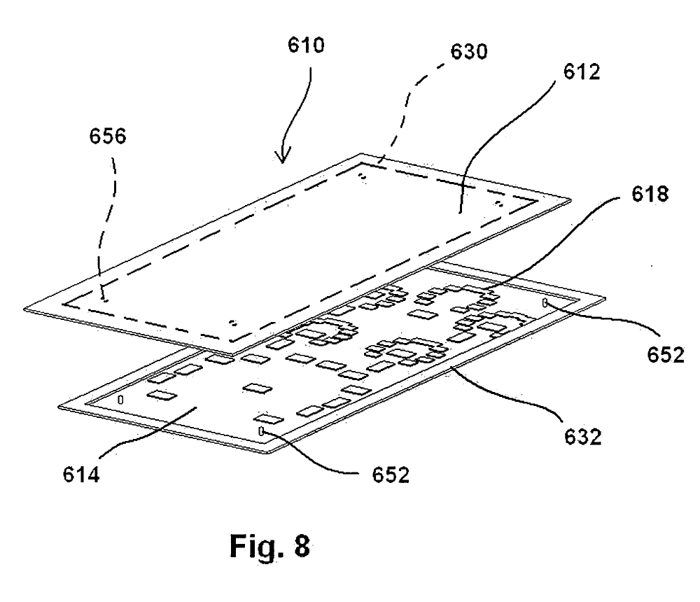

FIG. 8 shows another alternative preferred embodiment of the present invention. A first permanent magnet 630 is attached to a keypad 612. A second permanent magnet 632 is attached to a substrate 614. The first and second magnets 630,632 are preferably attached to the keypad 612 and substrate 614 respectively using a suitable adhesive such as epoxy or silicone. An insulating material 618, preferably a clear elastomeric insulating material such as silicone, is applied to the substrate 614. The insulating material 618 is preferably applied at a thickness adequate to fill any gap between the keypad 612 and the substrate 614.

Alignment protrusions 652 are preferably adhered to the substrate 614. Protrusions 652 mate with recesses 656 in the keypad 612 to properly align the keypad 612 with the substrate 614. Alternatively, the protrusions 652 may be positioned on the keypad 612 and recesses located on the substrate 614, or instead other types of alignment members may be employed to align the keypad 612 with the substrate 614.

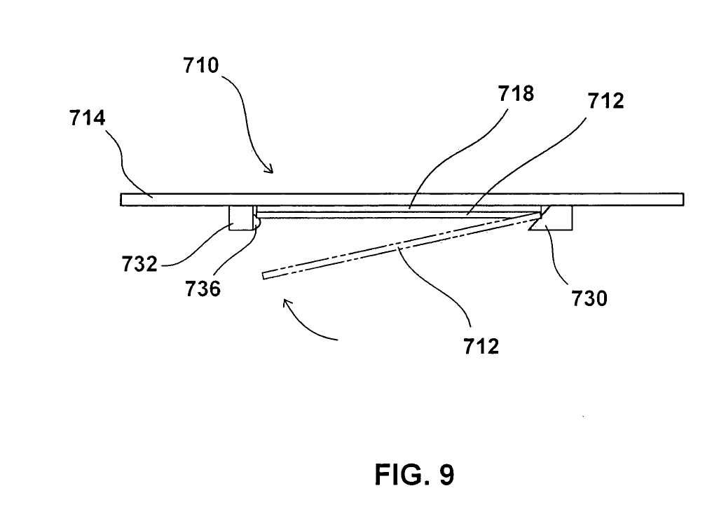

FIG. 9 shows another alternative preferred embodiment 710 of the present invention. In this embodiment, brackets 730, 732 are connected to a substrate 714 to removably retain a keypad 712. The brackets 730,732 are preferably permanently adhered to the substrate 714 using an adhesive, such as a silicone, rubber or acrylic-based pressure sensitive elastomeric adhesive. The brackets preferably extend a length of the keypad 712. Preferably, to maintain a uniform dielectric constant, a coating of insulating material 718, preferably a clear elastomeric material such as silicone, is applied and allowed to cure on one of the substrate 714 and the keypad 712. The insulating material 718 may be applied to the entire surface of the substrate 714 or keypad 712. Alternatively the insulating material 718 may be applied on the substrate 714 or the keypad 712, preferably via screen printing, in select locations corresponding to locations where touch sensors or other components, such as LEDs, are positioned on the keypad 712.

During assembly, the keypad 712 is positioned against and pivoted about the bracket 730, as shown in phantom line in FIG. 9, the direction of rotation being indicated by an arrow. A compliant detent 736 is provided on the bracket 732 to retain the keypad 712 after it is rotated into a position against the substrate 714 or against the insulating material 718, as shown. The detent 736 preferably includes an elastomeric material and deforms when an end of the keypad 712 makes contact with the detent 736 to allow the end of the keypad 712 to pass the detent 736 and be retained against the insulating material 718.

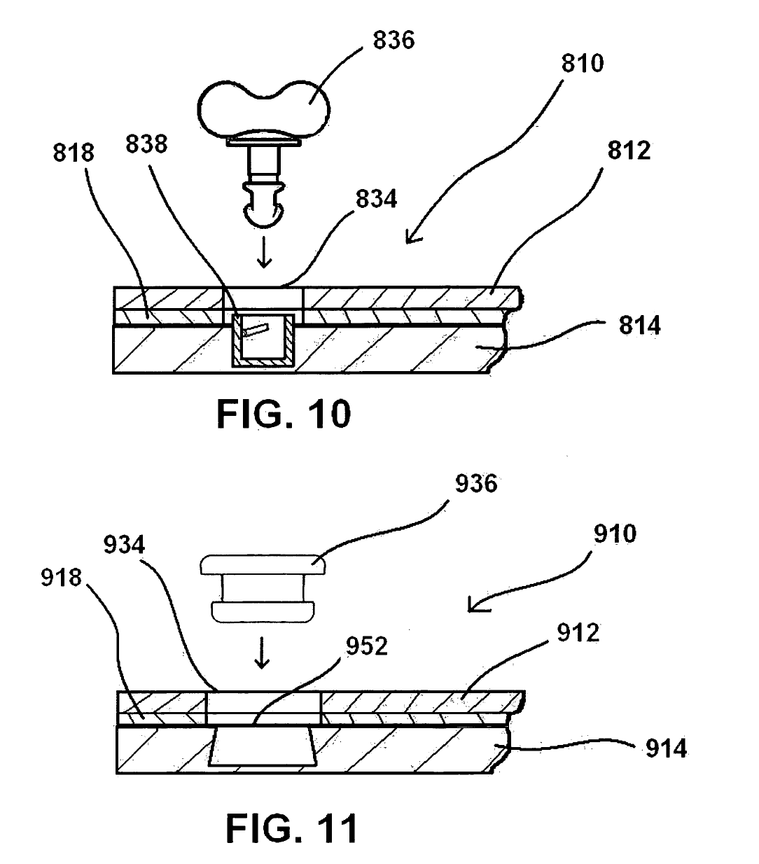

FIG. 10 shows another preferred embodiment 810. In this embodiment, a keypad 812 is connected to a substrate 814 using a quarter-turn screw 836. The quarter-turn screw 836 preferably connects with a receptacle 838 attached to the substrate 814. During use, the quarter-turn screw 836 is preferably inserted through an aperture 834 in the keypad 812, as indicated by an arrow in FIG. 10, and removably engages the receptacle 838 by rotating approximately one quarter of a revolution about its axis. An insulating material 818 is preferably positioned between the substrate 814 and the keypad 812.

FIG. 11 shows another preferred embodiment 910. In this embodiment, a keypad 912 is connected to a substrate 914 using a grommet 936. The grommet 936 preferably connects with an aperture 952 in the substrate 914 or other structure. During use, the grommet 936 is preferably inserted through an aperture 934 in the keypad 912, as indicated by an arrow in FIG. 11. An insulating material 918 is preferably positioned between the substrate 914 and the keypad 912.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention.

1. A touch control assembly comprising:
at least one of a glass and a glass-ceramic substrate for interfacing with a user; and
a touch keypad, including at least one sensor, removably connected to the substrate.

2. The touch control assembly of claim 1, further comprising at least one double-sided stretch release tape strip which connects the touch keypad with the substrate.

3. The touch control assembly of claim 1, further comprising at least one spring which urges the keypad against the substrate to connect the keypad to the substrate.

4. The touch control assembly of claim 1, further comprising at least one bracket connected to the substrate which removably connects the keypad to the substrate.

5. The touch control assembly of claim 1, further comprising at least one clip which removably connects the keypad to the substrate.

6. The touch control assembly of claim 1, further comprising at least one quarter-turn screw which removably connects the keypad to the substrate.

7. The touch control assembly of claim 1, further comprising at least one grommet which removably connects the keypad to the substrate.

8. The touch control assembly of claim 1, further comprising insulating material positioned between the touch keypad and the substrate.

9. The touch control assembly of claim 1, further comprising a layer of silicone positioned between the touch keypad and the substrate.

10. The touch control assembly of claim 1, further comprising a coating of insulating material adhered to at least one of the keypad and the substrate.

11. The touch control assembly of claim 1, further comprising insulating material positioned to correspond to a position of the at least one sensor between the touch keypad and the substrate.

12. The touch control assembly of claim 1, further comprising an insulating material which is at least one of sprayed, screen printed and stencil printed and cured on at least one of the keypad and the substrate.

13. The touch control assembly of claim 1, further comprising a clear elastomer insulating layer adhered to at least one of the keypad and the substrate.

14. The touch control assembly of claim 1, wherein the at least one sensor includes a capacitive type sensor.

15. The touch control assembly of claim 1, further comprising a controller connected to the keypad.

16. A touch control assembly comprising:
a touch keypad including at least one sensor;
a substrate for interfacing with a user; and
at least one double-sided stretch release tape strip which connects the touch keypad with the substrate.

17. The touch control assembly of claim 16, wherein the substrate includes at least one of a glass and a glass ceramic plate.

18. The touch control assembly of claim 16, wherein the stretch release tape strip includes a release tab which extends past an edge of at least one of the keypad and the substrate.

19. The touch control assembly of claim 16, further comprising an insulating material positioned to correspond to a position of the at least one sensor.

20. The touch control assembly of claim 16, further comprising insulating material positioned between the touch keypad and the substrate.

21. The touch control assembly of claim 16, further comprising insulating material, having substantially the same thickness as a thickness of the at least one tape strip, positioned between the touch keypad and the substrate adjacent to the at least one tape strip.

22. A touch control assembly comprising:
a touch keypad;
a substrate for interfacing with a user;
at least one bracket connected to the substrate which removably connects the keypad to the substrate.

23. The touch control assembly of claim 22, wherein the at least one bracket is adhered to the substrate using an adhesive.

24. The touch control assembly of claim 22, wherein the at least one bracket includes a Z-bracket having a raised portion, and wherein the at least one keypad bracket is slidably retained by the raised portion of the at least one bracket.

25. The touch control assembly of claim 22, further comprising insulating material positioned between the touch keypad and the substrate.

26. The touch control assembly of claim 22, further comprising a spring connected to at least one of the bracket and the substrate which urges the keypad toward the substrate.

27. The touch control assembly of claim 22, further comprising a spring removably connected to the bracket which urges the keypad toward the substrate.

28. The touch control assembly of claim 22, wherein the at least one bracket includes at least two brackets, and further comprising a spring which is removably connected to the at least two brackets which urges the keypad toward the substrate.

29. The touch control assembly of claim 22, further comprising a locating member connected to the substrate for positioning the keypad relative to the substrate.

30. The touch control assembly of claim 22, wherein the at least one bracket includes at least a first and a second bracket, and wherein the at least the first bracket retains a first end of the keypad and the at least the second bracket includes a compliant detent for removably retaining a second end of the keypad against the substrate.

31. A touch control assembly comprising:
a touch keypad;
a substrate for interfacing with a user; and
at least one clip which removably connects the keypad to the substrate.

32. The touch control assembly according to claim 31, wherein the at least one clip is a tree clip.

33. The touch control assembly according to claim 31, further comprising a thin material sheet, wherein the at least one clip is connected to the thin material sheet.

34. The touch control assembly according to claim 31, further comprising a thin material sheet, wherein the at least one clip is connected to the thin material sheet, and the thin material sheet is adhered to the substrate.

35. The touch control assembly according to claim 31, further comprising a thin material sheet and at least one strip of VHB tape, wherein the at least one clip is adhered to the thin material sheet, and the thin material sheet is adhered to the substrate with the at least one strip of VHB tape.
